(19) United States
(12) Patent Application Publication
(10) Pub. No.: US 2012/0265599 A1
(43) Pub. Date: Oct. 18, 2012

(54) TEMPORAL TRACKING OF MOBILE USER BEHAVIOR WITH RESPECT TO WEB-BASED ADVERTISEMENTS ASSOCIATED WITH TEMPORARY AND KEYED ID USE IN DIGITAL MEDIA CONTENT

(75) Inventors: Mark Douglas Corner, Williamsburg, MA (US); Micah Adler, Boston, MA (US); Mustafa Ihsan Ecemis, Boston, MA (US); Keith Gabryelski, Brookline, MA (US)

(73) Assignee: Fiksu, Inc., Boston, MA (US)

(21) Appl. No.: 13/447,054

(22) Filed: Apr. 13, 2012

Related U.S. Application Data
(60) Provisional application No. 61/475,538, filed on Apr. 14, 2011.
(60) Provisional application No. 61/499,597, filed on Jun. 21, 2011.
(60) Provisional application No. 61/515,152, filed on Aug. 4, 2011.
(60) Provisional application No. 61/562,107, filed on Nov. 21, 2011.

(51) Int. Cl. G06Q 30/02

(52) U.S. Cl. 705/14.35; 705/14.39

(57) ABSTRACT

A method for tracking downloads of digital media content is disclosed. Digital media content, such as music, games and applications (“apps”) are widely available with the popularity of mobile computing. Content suppliers would appreciate it if their works were more widely disseminated and used. Users or customers may receive an incentive to purchase or to download an application. The incentive may be, for example, a free application, rewards points or a virtual currency. In one method, a user downloads digital media content and receives the incentive in two stages. In the first stage, a user who has expressed interest is sent a first web-based link offering the content and the incentive. In the second stage, after activating the link, the user is allowed to download the content and receive the inventive. The web-based link includes user identifiers that are matched for the user to receive the incentive.

### BACKGROUND

1. Field

This invention relates to promotion and advertising of digital media and services, such as applications and premium access to content designed for use on smart phones and other portable and mobile devices.

2. Description of Related Art

Applications designed for use on smart phones, such as the Android® and iPhone®, as well as portable and mobile devices such as iPad and iPod, are rapidly proliferating making it difficult for developers and publishers of new applications to get the attention of consumers who would benefit from knowing about them. A need exists for methods and systems that help developers and publishers of new mobile applications and other digital media to promote their developments.

An ecosystem has evolved that includes application developers and publishers, and advertising networks that offer opportunities to advertise new mobile applications. Within that ecosystem, it is possible to offer an incentivized download of an application, i.e., a download that comes with some form of incentive that is designed to encourage purchase or trial of the application or service. An incentive may be offered to the consumer directly, or may be offered to a third party, such as a site that promotes downloading of particular applications. However, significant challenges still exist for publishers and developers, and a need exists for methods and systems that help publishers and developers optimize the promotion of their new applications within this emerging ecosystem.

### SUMMARY

The present invention provides for methods and systems to track user actions on a mobile electronics device, such as the use of mobile digital media incentive management through multiple user action tracking despite the mobile electronics device lacking traditional facilities for linking such actions, mobile digital media incentive management through tracking of an identifier in native facilities of the mobile device, mobile digital media management utilizing statistical user fingerprinting techniques through correlation of web-based download user actions with application download user actions, temporal tracking of mobile user behavior with respect to web-based advertisements associated with temporary and keyed identifier use in digital media content, rewarding a user for downloading, purchasing, and/or using an application with the right to use another application or be provided a service for free (e.g. an in-app purchase, such as a purchase of a premium membership at a discount), and the like.

In embodiments, a method may be provided for tracking downloads in a computer system that includes a mobile electronics device, the method comprising: providing an incentive to a user of the mobile electronics device for the download of digital media content; receiving a request for the digital media content from the user of the mobile electronics device; sending the user an electronic communication to the mobile electronic device including a first web-based link and a second web-based link that the user is instructed to activate in a specified order to receive both the digital media content and the incentive, wherein the user is to first activate the first link and then the second link, and wherein the first and second links contain an embedded user identifier; receiving an indication of the user having activated the first web-based link, wherein activation of the first web-based link results in receiving the user identifier that was embedded in the first link and enables the user to download the digital media content to the mobile electronics device; and receiving an indication of the user having activated the second web-based link, wherein activation of the second web-based link results in receiving the user identifier that was embedded in the second link and enables the user to open the digital media content on the mobile electronic device, creates a confirmation event through matching of the two received user identifiers present in the activation of the first and second web-based links, and provides the user with the incentive. In embodiments, the digital media content may be an application, music, video, a game, and the like. The incentive may be an application, reward points, video, music, virtual currency, and the like. The confirmation event may be generated at least in part from the mobile electronic device being caused to direct a call to a URL and to record the call as the confirmation event as a result of receiving the indication of the user having activated the second web-based link. The mobile communications device may use sandboxing to prevent direct sharing of data between applications.

In embodiments, a method may be provided for tracking an incentivized action in a computer system that includes a mobile electronics device, the method comprising: providing an incentive to a user of the mobile electronics device for use of a digital media content; receiving a request for use of the digital media content from the user of the mobile electronics device; sending the user an electronic communication to the mobile electronic device including a first web-based link and a second web-based link that the user is instructed to activate in a specified order to receive both the use of the digital media content and the incentive, wherein the user is to first activate the first link and then the second link, and wherein the first and second links contain an embedded user identifier; receiving an indication of the user having activated the first web-based link, wherein activation of the first web-based link results in receiving the user identifier that was embedded in the first link and enables the user to access the digital media content through the mobile electronics device; and receiving an indication of the user having activated the second web-based link, wherein activation of the second web-based link results in receiving the user identifier that was embedded in the second link and enables the user to use the digital media content on the mobile electronic device, creates a confirmation event through matching of the two received user identifiers present in the activation of the first and second web-based links, and provides the user with the incentive. In embodiments, the use of the digital media content may include the purchase of the digital media content. In embodiments, the digital media content may be an application, music, video, a game, and the like. The incentive may be an application, reward points, video, music, virtual currency, and the like.

In embodiments, a method may be provided for tracking an incentivized action in a computer system that includes a mobile electronics device, the method comprising: providing an incentive to a user of the mobile electronics device for a web-based service; receiving a request for the web-based service from the user of the mobile electronics device; sending the user an electronic communication to the mobile electronic device including a first web-based link and a second web-based link that the user is instructed to activate in a specified order to receive both the web-based service and the incentive, wherein the user is to first activate the first link and then the second link, and wherein the first and second links contain an embedded user identifier; receiving an indication of the user having activated the first web-based link, wherein activation of the first web-based link results in receiving the user identifier that was embedded in the first link and enables the user to access the service through the mobile electronics device; and receiving an indication of the user having activated the second web-based link, wherein activation of the second web-based link results in receiving the user identifier that was embedded in the second link and enables the user to use the web-based service through the mobile electronic device, creates a confirmation event through matching of the two received user identifiers present in the activation of the first and second web-based links, and provides the user with the incentive. In embodiments, the web-based service may be an in-app purchase. The in-app purchase may be a purchase of a premium membership at a discount.

In embodiments, a method may be provided for tracking downloads in a computer system that includes a mobile electronics device, the method comprising: providing an incentive to a user of a mobile electronics device for the download of digital media content, wherein the incentive requires the user to provide access to an identifier of the user's mobile device that is stored as a native facility on the mobile device; receiving a request for the digital media content from the user of the mobile electronics device as the result of the incentive, wherein the request includes access to the identifier; sending the user an electronics communication to the mobile electronic device including a first web-based link and a second web-based link that the user is instructed to activate in a specified order to receive both the digital media content and the incentive, wherein the user is to first activate the first link and then the second link, and wherein the first and second links contain the identifier; receiving an indication of the user having activated the first web-based link, wherein activation of the first web-based link results in receiving the identifier and enables the user to download the digital media content to the mobile electronics device; and receiving an indication of the user having activated the second web-based link, wherein activation of the second web-based link results in receiving the identifier and enables the user to open the digital media content on the mobile electronic device, creates a confirmation event through matching of the two received identifiers present in the activation of the first and second web-based links, and provides the user with the incentive. In embodiments, the native facility that stores the identifier may be a response from a request for identification. The native facility that stores the identifier may be associated with a device management server. The device management server may be used to verify an installation of an application by viewing whether the application is installed, prompting the user to install it, and then checking with the device management server to verify that the application has been installed. The digital media content may be an application, music, video, a game, and the like. The incentive may be an application, reward points, video, music, virtual currency, and the like. The confirmation event may be generated at least in part from the mobile electronic device being caused to direct a call to a URL and to record the call as the confirmation event as a result of receiving the indication of the user having activated the second web-based link.

In embodiments, a method may be provided for tracking an incentivized action in a computer system that includes a mobile electronics device, the method comprising: providing an incentive to a user of a mobile electronics device for the use of a digital media content, wherein the incentive requires the user to provide access to an identifier of the user's mobile device that is stored as a native facility on the mobile device; receiving a request for the use of the digital media content from the user of the mobile electronics device as the result of the incentive, wherein the request includes access to the identifier; sending the user an electronics communication to the mobile electronic device including a first web-based link and a second web-based link that the user is instructed to activate in a specified order to receive both the use of the digital media content and the incentive, wherein the user is to first activate the first link and then the second link, and wherein the first and second links contain the identifier; receiving an indication of the user having activated the first web-based link, wherein activation of the first web-based link results in receiving the identifier and enables the user to use the digital media content through the mobile electronics device; and receiving an indication of the user having activated the second web-based link, wherein activation of the second web-based link results in receiving the identifier and enables the user to use the digital media content through the mobile electronic device, creates a confirmation event through matching of the two received identifiers present in the activation of the first and second web-based links, and provides the user with the incentive. In embodiments, the use of the digital media content may include the purchase of the digital media content. In embodiments, the digital media content may be an application, music, video, a game, and the like. The incentive may be an application, reward points, video, music, virtual currency, and the like.

In embodiments, a method may be provided for tracking an incentivized action in a computer system that includes a mobile electronics device, the method comprising: providing an incentive to a user of a mobile electronics device for a web-based service, wherein the incentive requires the user to provide access to an identifier of the user's mobile device that is stored as a native facility on the mobile device; receiving a request for the web-based service from the user of the mobile electronics device as the result of the incentive, wherein the request includes access to the identifier; sending the user an electronics communication to the mobile electronic device including a first web-based link and a second web-based link that the user is instructed to activate in a specified order to receive both the web-based service and the incentive, wherein the user is to first activate the first link and then the second link, and wherein the first and second links contain the identifier; receiving an indication of the user having activated the first web-based link, wherein activation of the first web-based link results in receiving the identifier and enables the user to use the web-based service through the mobile electronics device; and receiving an indication of the user having activated the second web-based link, wherein activation of the second web-based link results in receiving the identifier and enables the user to use the web-based service through the mobile electronic device, creates a confirmation event through matching of the two received identifiers present in the activation of the first and second web-based links, and provides the user with the incentive. In embodiments, the web-based service may be an in-app purchase. The in-app purchase may be a purchase of a premium membership at a discount.

In embodiments, a method may be provided for tracking downloads in a computer system that includes at least one mobile electronics device, the method comprising: providing an incentive to a plurality of users of mobile electronics devices for the download of digital media content, wherein the incentive is provided through both an app download environment and a web browsing environment; receiving a first indication from at least one of the plurality of users that demonstrates interest in the incentive in at least one of the environments, wherein the indication provides user-related data; receiving a second indication from at least one of the plurality of users from the other environment, wherein the indication provides user-related data that enables matching it to the user-related data from the received first indication; determining a correlation between the user related data from the first indication and the user-related data from the second indication to predict a user action in at least one of the environments; sending the user of the matched user-related data an electronic communication to their mobile electronic device that includes a link that offers the user the incentive to receive both the digital media content and the incentive while maintaining an indicator of the matched user-related data; receiving an indication of the user having activated the link, wherein activation of the link results in receiving an indicator of the matched user-related data; and providing the user with the ability to download the digital media content and receive the incentive. In embodiments, the digital media content may be an application, music, video, a game, and the like. The incentive may be an application, reward points, video, music, game, virtual currency, and the like. The system may track the download of the digital media content and the incentive on a per-user basis.

In embodiments, a method may be provided for tracking an incentivized action in a computer system that includes at least one mobile electronics device, the method comprising: providing an incentive to a plurality of users of mobile electronics devices for the use of a digital media content, wherein the incentive is provided through both an app environment and a web browsing environment; receiving a first indication from at least one of the plurality of users that demonstrates interest in the incentive in at least one of the environments, wherein the indication provides user-related data; receiving a second indication from at least one of the plurality of users from the other environment, wherein the indication provides user-related data that enables matching it to the user-related data from the received first indication; determining a correlation between the user related data from the first indication and the user-related data from the second indication to predict a user action in at least one of the environments; sending the user of the matched user-related data an electronic communication to their mobile electronic device that includes a link that offers the user the incentive to receive both the use of the digital media content and the incentive while maintaining an indicator of the matched user-related data; receiving an indication of the user having activated the link, wherein activation of the link results in receiving an indicator of the matched user-related data; and providing the user with the ability to use the digital media content and receive the incentive. In embodiments, the use of the digital media content may include the purchase of the digital media content. In embodiments, the digital media content may be an application, music, video, a game, and the like. The incentive may be an application, reward points, video, music, virtual currency, and the like.

In embodiments, a method may be provided for tracking an incentivized action in a computer system that includes at least one mobile electronics device, the method comprising: providing an incentive to a plurality of users of mobile electronics devices for a web-based service, wherein the incentive is provided through both an app environment and a web browsing environment; receiving a first indication from at least one of the plurality of users that demonstrates interest in the incentive in at least one of the environments, wherein the indication provides user-related data; receiving a second indication from at least one of the plurality of users from the other environment, wherein the indication provides user-related data that enables matching it to the user-related data from the received first indication; determining a correlation between the user related data from the first indication and the user-related data from the second indication to predict a user action in at least one of the environments; sending the user of the matched user-related data an electronic communication to their mobile electronic device that includes a link that offers the user the incentive to receive both the web-base service and the incentive while maintaining an indicator of the matched user-related data; receiving an indication of the user having activated the link, wherein activation of the link results in receiving an indicator of the matched user-related data; and providing the user with the ability to use the web-based service and receive the incentive. In embodiments, the web-based service may be an in-app purchase. The in-app purchase may be a purchase of a premium membership at a discount.

In embodiments, a method may be provided for tracking downloads in a computer system, the method comprising: providing an incentive to a plurality of users of mobile electronics devices for the download of digital media content; receiving a first indication from at least one of the plurality of users that demonstrates interest in the incentive, wherein the indication provides a first application-specific user identifier; receiving a second indication from at least one of the plurality of users that demonstrates interest in the incentive, wherein the indication provides a second application-specific user identifier that matches the first application-specific user identifier from the received first indication; sending the user of the matched application-specific user identifier an electronic communication to the user's mobile electronic device that includes a link that offers the user both the digital media content and the incentive, while maintaining an indicator of matched application-specific user identifier; receiving an indication of the user having activated the link, wherein activation of the link results in receiving the matched application-specific user identifier; and providing the user with the ability to download the digital media content and receive the incentive. In embodiments, the application-specific user identifier may be a time-limited user identifier. The application-specific user identifier may be a user identifier that is keyed to a specific application. The digital media content may be an application, music, video, a game, and the like. The incentive may be an application, reward points, music, video, game, virtual currency, and the like.

In embodiments, a method may be provided for tracking an incentivized action in a computer system, the method comprising: providing an incentive to a plurality of users of mobile electronics devices for the use of a digital media content; receiving a first indication from at least one of the plurality of users that demonstrates interest in the incentive, wherein the indication provides a first application-specific user identifier; receiving a second indication from at least one of the plurality of users that demonstrates interest in the incentive, wherein the indication provides a second application-specific user identifier that matches the first application-specific user identifier from the received first indication; sending the user of the matched application-specific user identifier an electronic communication to the user's mobile electronic device that includes a link that offers the user both the use of the digital media content and the incentive, while maintaining an indicator of matched application-specific user identifier; receiving an indication of the user having activated the link, wherein activation of the link results in receiving the matched application-specific user identifier; and providing the user with the ability to use the digital media content and receive the incentive. In embodiments, the use of the digital media content may include the purchase of the digital media content. In embodiments, the digital media content may be an application, music, video, a game, and the like. The incentive may be an application, reward points, video, music, virtual currency, and the like.

In embodiments, a method may be provided for tracking an incentivized action in a computer system, the method comprising: providing an incentive to a plurality of users of mobile electronics devices for a web-based service; receiving a first indication from at least one of the plurality of users that demonstrates interest in the incentive, wherein the indication provides a first application-specific user identifier; receiving a second indication from at least one of the plurality of users that demonstrates interest in the incentive, wherein the indication provides a second application-specific user identifier that matches the first application-specific user identifier from the received first indication; sending the user of the matched application-specific user identifier an electronic communication to the user's mobile electronic device that includes a link that offers the user both the web-based service and the incentive, while maintaining an indicator of matched application-specific user identifier; receiving an indication of the user having activated the link, wherein activation of the link results in receiving the matched application-specific user identifier; and providing the user with the ability to use the web-based service and receive the incentive. The web-based service may be an in-app purchase. The in-app purchase may be a purchase of a premium membership at a discount.

In embodiments, a method may be provided for tracking downloads in a computer system, the method comprising: providing an incentive to a plurality of users of mobile electronics devices for the free download of a first digital media content where the incentive for the first digital media content is linked through a set of subsequent user actions with the first digital media content to a further incentive for the right to download of a second digital media content; receiving a request for the first digital media content from the user of the mobile electronics device as the result of the incentive, wherein the request includes a user identifier; tracking the user's actions with the first digital media content using the user identifier; and providing the user with the right to download the second digital media content when the user satisfies the incentivized linked user actions associated with the first digital media content. In embodiments, the first and second digital media content may be an application, music, video, a game, and the like. The incentive may be an application, reward points, music, video, virtual currency, and the like. Identification of the device may be provided through an externally visible and verifiable action that is unique to at leas on of the device and user such as a public review, modification of a wish-list, friend association, leader board position, achievement record, device management configuration state, notification between the store and advertiser, and the like.

In embodiments, a method may be provided for tracking an incentivized action in a computer system, the method comprising: providing an incentive to a plurality of users of mobile electronics devices for the use of a first digital media content where the incentive for the use of the first digital media content is linked through a set of subsequent user actions with the first digital media content to a further incentive for the right to use of a second digital media content; receiving a request for the use of the first digital media content from the user of the mobile electronics device as the result of the incentive, wherein the request includes a user identifier; tracking the user's actions with the use of the first digital media content using the user identifier; and providing the user with the right to use the second digital media content when the user satisfies the incentivized linked user actions associated with the first digital media content. In embodiments, the use of the digital media content may include the purchase of the digital media content. In embodiments, the digital media content may be an application, music, video, a game, and the like. The incentive may be an application, reward points, video, music, virtual currency, and the like.

In embodiments, a method may be provided for tracking an incentivized action in a computer system, the method comprising: providing an incentive to a plurality of users of mobile electronics devices for the use of a first web-based service where the incentive for the use of the first web-based service is linked through a set of subsequent user actions with the first digital media content to a further incentive for the right to use a second web-based service; receiving a request for the use of the first web-based service from the user of the mobile electronics device as the result of the incentive, wherein the request includes a user identifier; tracking the user's actions with the use of the web-based service using the user identifier; and providing the user with the right to use the second web-based service when the user satisfies the incentivized linked user actions associated with the first web-based service. In embodiments, the web-based service may be an in-app purchase. The in-app purchase may be a purchase of a premium membership at a discount.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts an ecosystem functional diagram in an embodiment of the present invention.

FIG. 2 depicts a top-level block process flow diagram in embodiments of methods and systems.

FIG. 3 depicts a tracking list example.

FIG. 4 depicts a flow diagram for utilizing existing functionalities in a mobile device to implement a linking of interest and use of an application.

FIG. 5 depicts an alternate flow diagram for utilizing existing functionalities in a mobile device to implement a linking of interest and use of an application.

FIG. 6 depicts a user interface embodiment for an App-Exchanger.

FIG. 7 depicts an embodiment of a mobile website with embedded advertisement.

FIG. 8 depicts a user interface embodiment for a profile service.

FIG. 9 depicts a user interface embodiment for a profile service with an install profile message to a user.

FIG. 10 depicts a functional block diagram of a system implementation in an embodiment of the present invention.

While the invention has been described in connection with certain preferred embodiments, other embodiments would be understood by one of ordinary skill in the art and are encompassed herein.

### DETAILED DESCRIPTION

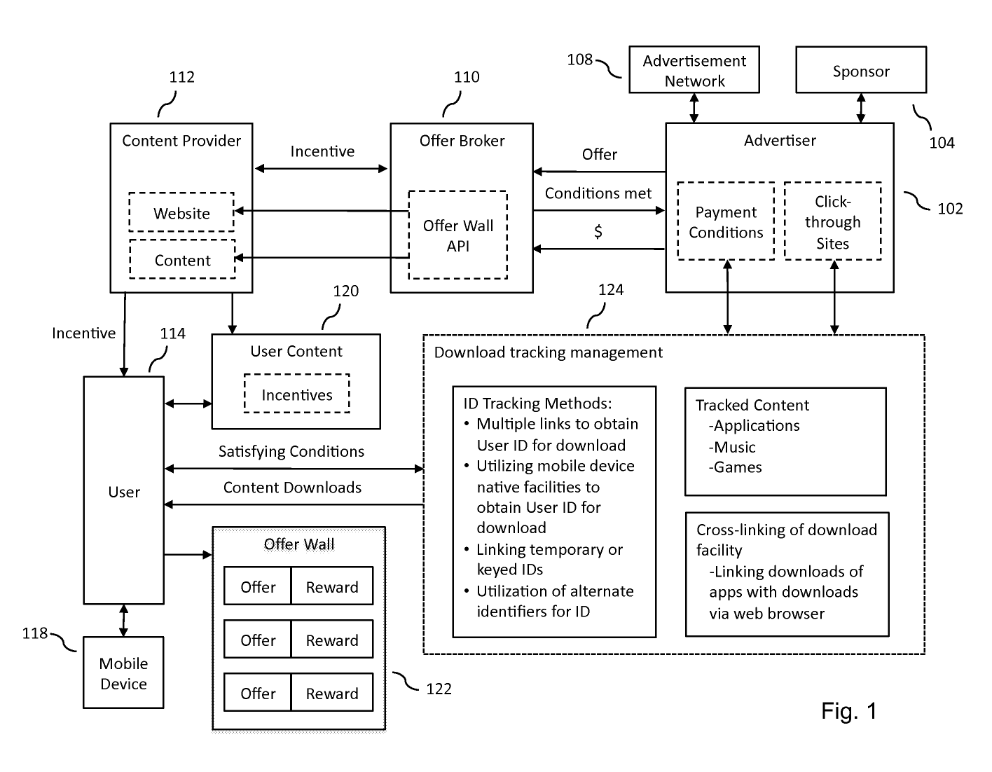

In embodiments, methods and systems may provide for using incentives to promote downloads of mobile applications (also referred to as ‘apps’ herein), games, music, video, podcast, and other digital media, such as in association with third party services that help developers promote their applications (e.g., Tapjoy); a non-incentivized tracking facility such as where the item associated with the facility has the value (e.g. a song, a paid application) and the facility provides a tracking for purchases; and the like. These third-party services may have an existing large network of publishers that serve incentivized downloads. FIG. 1 depicts an environment within which methods and systems may be provided, including advertisers 102 in connectivity with sponsors 104 and advertisement networks 108, an offer broker 110, content provider 112, a user 114, a user mobile device 118, a user content 120, an offer wall 122, and download tracking management 124. For instance, a sponsor 104, possibly through an advertisement network 108, may work with an advertiser 102 to utilize download tracking management 124 to provide inducements to users 114 for them to download content to their mobile device 118. Incentives may be provided to users 114 in the form of virtual currency, free applications, reward points, and the like. Methods and systems of the present invention may utilize download tracking management 124 to link download actions of a user 114 to verify that the user 114 has satisfied certain conditions that are provided to the user as a requirement for benefits, such as a free application, a free song, virtual currency for a game, rewards points, and the like. Download tracking management may utilize a plurality of methods for ID tracking of a user 118, such as utilizing multiple links to obtain a user ID for download, utilizing native facilities on a mobile device 118 to obtain a user ID for a download, linking temporary or keyed IDs, utilizing alternate identifiers as an ID, and the like. Download tracking management may utilize statistical methods to aid in the matching of user actions, such as cross-linking of downloads of apps with downloads via a web browser, and the like.

In embodiments, the system may pay the third-party to get downloads for one of the applications being promoted. For instance, the third-party pays a publisher for access to the opportunity to present an application to the users that the publisher has (e.g., users of a specific game offered by the publisher). That publisher may incentivize the users that it has to download applications that the system is trying to promote, such as by giving the user virtual currency within the game. For instance, the user may get “fish-bucks.” In such a method and system the game publisher operates the game and receives revenue in exchange for promoting the download or use of the application developer's application by users of the game. In turn, the system gets downloads for the applications, thereby promoting adoption by the users of the game.

In embodiments, there may be alternative ways to accomplish promotion of downloads of applications. For instance, methods and systems may promote downloads by working with rewards programs (e.g. MyPoints), where there is access to large numbers of users, such as, in the case of MyPoints, some 10,000,000 or more users. Users will do things for points within the rewards program. They may buy things, take points, and the like. The idea may include giving users points from rewards programs in exchange for the user downloading an application, or using it to some extent.

In embodiments, promotion of downloads may include a process flow where a user downloads free apps, a user is provided a reward as a right to use another app for free, a user is downloads a paid app and the user is provided points or credits for the download, a user downloads a paid app and the user receives a paid app of equal or lesser value for free, and the like. For instance, a user at a website may be told to download a first app (e.g. a ‘free app’) and that the system will provide them with a certain number of credits for downloading the app. The user may then use the credits, when enough are accumulated (such as from additional downloads), to download a second app. This second app may be referred to as a ‘gift’ app, which may nevertheless still be a sponsored app from a customer of the system that is also trying to promote the second app. In effect, the user gets something for free (the first app), which if they use it, may entitle them to get something else for free (the second app). From the system's point of view, if people bring traffic to the first app, they get to bring traffic to another app. In an example, if a person downloads 2-3 free apps, and they accumulate points for each download, this may enable them to get some other app(s) for free. In embodiments, implementation of such a process may include the use of a computing stack, such as the Apple® stack as described herein, to get the ID of the device so as to link to the later app download install.

In embodiments, a technology component of the system may include the tracking of what the user actually does in connection with an application. The challenge here is that a person may, for example, start in one third-party application, such as a mobile web browser like mobile Safari® but download another third-party application. With that flow, the initial application, such as the browser has access to the device ID (unique identifier) of the device on which the download is occurring. When the user downloads the application, the system will preferably get access to the device ID again, allowing tracking of the download of that application by that user. However, in some systems, such as the iPhone®, iPad® and other systems offered by Apple Computer, there may be no way to directly track that a particular download is initiated because of a specific action (e.g. an advertisement, pitch, value trade, and the like), because such systems do not have cookies or similar downloaded elements that are used in other contexts, such as online tracking systems for personal computers, to track online actions of users. For instance, cookies, HTML5 local storage and databases, and similar objects were originally designed to help a website distinguish a user's browser as a previous visitor and thus save and remember any preferences that may have been set while the user was browsing the site. A cookie is a small string of text that a website can send to the user's browser for storage on the user's local computer and retrieval the next time that computer visits a website. Website publishers use cookies to enhance the user's visit. In general, cookies can be used by publishers to securely store a user's ID and password, personalize home pages, identify which parts of a site have been visited, keep track of selections in a “shopping cart,” and the like. Currently, Apple's mobile devices do not support the sharing of cookies and the like between third-party applications, meaning that a third-party application publisher or party tracking application usage cannot easily retrieve a stored object to determine that a user is returning to that application, or to determine what user is downloading the application. This makes it very difficult to track mobile device user behavior in connection with a download with the conventional techniques used to track use of fixed online devices like personal computers.

In embodiments, methods and systems may be able to provide tracking despite not having access to the initial UDID (unique device identifier), using a series of intermediate URLs for tracking what a user does on the device. At a high level of description, the initial click may go through a re-direct on the system servers, and users may have to provide a second action to link the initial click with access to the UDID or other unique identifier, such as a second click on the application that goes through the re-direct a second time that launches the application, provide an action in the mobile application itself (e.g. clicking on a link, clicking on a linked object), providing a code within the application, opening the application, closing the application, and the like. In the cases such as opening and closing the application, the application may redirect to the browser through such a mechanism as openURL on iOS with the browser then redirecting back to the application using an automatic second-click action. Alternatively, only a single click may be enough for the system to work, where the single click redirects to the application by passing in the user identifier as a parameter. Then, the application may upload the user identifier together with the UDID (e.g. the application can access the UDID) and the system ties them.

In embodiments, a UDID may be temporary, such as with a UDID that is time-limited, a UDID that expires, and the like. In this instance, the system may be able to link or string together the temporary UDID(s) through time. For example, a user might click on an advertisement associated with one app, then click on an advertisement associated with another app over the course of a couple of weeks (an example of a possible duration of a time-limited UDID). Over this time interval, the system may be able to link those two events together, thus matching or linking the time-limited UDIDs. In embodiments, the system may be able to link UDIDs to each other over time periods, so that the system can have a semi-stable or persistent meta-UDID in an environment where only a time-limited UDID is provided.

In embodiments, UDIDs may be keyed, where different apps receive different UDIDs, apps with a certain password may receive a UDID, and the like. For example, one app could provide a password and get back a UDID, and any other app with the same password would get back the same UDID. In this instance, the system may link or match UDIDs through tracking and associating the UDIDs over time, in a similar manner to how temporary UDIDs are tracked.

In embodiments, there may be alternatives to using UDIDs as identifiers. For instance, a MAC address may be used as an identifier. The MAC address may be acquired through a provisioning profile, mobile device management servers, and the like, such as in a similar manner to how a UDID is acquired from a web page. The MAC address may be used for identification purposes, much like a UDID would be used. In another instance, a copy-and-paste function, copy-and-paste buffer, and the like, may be used as a proxy or substitute for the UDID. For instance, the system may store information in a copy-and-paste buffer in one app, and then retrieve and install that information into another app. This technique may be used as a general, generic replacement for UDIDs (e.g., for two game apps by the same developer). These techniques may also be used to keep track of subscriptions, and the like. For instance, a user may buy a subscription to an app, and in order to get the subscription back, the system may use a UDID to find a previous subscription from the user. In this way, the system may preserve states across apps, installs, and the like.

In embodiments, there may be a process through which tracking is enabled through a system such as the Apple system, where the lack of cookies and URL exchanges between applications make it more difficult to execute tracking. The tracking of downloads from placement, to click, to install is important if the system of incentivized downloads is to be effective. For instance, without tracking, the system may not be able to determine the effectiveness of a particular advertisement and so could not optimize its placement, or more importantly, may not have incentivized the user, which would prohibit running incentivized campaigns. In embodiments, the system may want to launch a campaign using services like “MyPoints” which offers points (e.g. redeemable for discounts, airline rewards, etc.) and offer users points in exchange. One problem is that there is no direct information sharing between iPhone/iPad applications and other iPhone/iPad applications or Mobile Safari® (the browser favored by Apple for use on its mobile devices). Those devices are not configured to share cookies, HTML5 databases, caches, bookmarks, or the like. Also, there may be no way to read identifying information (typically meaning a device ID, such as the iPhone UDID) from some mobile browsers, such as Mobile Safari. To see why this tracking is difficult, consider what happens if a user clicks on a mobile advertisement on a mobile web page using Mobile Safari®. That click takes the user through some number of redirections and then lands the user in the iTunes® Apple app store. At that point all the advertisement provider knows is simple information like the user's IP address and can set cookies, etc. Later that user may install an app based on that click to the app store. Even if the application sends the UDID to an incentivized download system as described herein, there is not a link to the user's UDID to the click (the system can't read the same cookies, cache, or the like). In one embodiment the solution to this challenge may be to require the user to help make the linking between the first click and the later install by clicking on a second link. This may work when the user has some kind of incentive to help the system make the link (like MyPoints or other rewards where the users are incentivized).

In a non-limiting example, the tracking may work in three steps (but where the user may only have to click twice). In this instance, the user is sent an email with two links in it. In step 1, the user clicks on the first link in the email to install the application. That link goes to a URL, such as:

http://track.fluentmobile.com/conversion?

name=fminitinstall&id=123456&app=312886230

The mpid is the “MyPoints id” which is put into the email by MyPoints (for other services they should have some other unique id assigned to the user). The appid is the iTunes application id. The server at track.fluentmobile.com records this in a database as an event and redirects the link, such as to http://itunes.apple.com/us/app/id312886230. There the user may install the application.

In step 2, after installing the application, the user clicks on the second link in the email. That link may look like this:

http://track.fluentmobile.com/conversion?

name=fmclickinstall&id=123456&app=312886230

Containing the same MyPoints id and app id. The server at track.fluentmobile.com records this as an event and then redirects to a link, such as:

app312886230://fmfinishinstall?tvalue=123456&ivalue=0

where the appXXX:// has XXX filled in with the iTunes app id. Because the publisher of that application has integrated the system's tracking code, as described herein, this will open up that application on the user's phone. When the application opens, the parameters in that URL will be fed into a method in that application (again because the integration code has this in it), that then fires step 3 and the application opens and makes a call to a URL, such as:

http://track.fluentmobile.com/conversion?

name=fmfinishinstall&udid=THEUDID&tvalue=123456&app=312886230

where THEUDID is filled in with the user's udid and the tvalue is filled in with the MyPoints id. The server at track.fluentmobile.com records this as the third event. At the conclusion there should be three events in the database:

1. fminstall includes MyPopints id and app id

2. fmclickinstall includes MyPoints id and app id

3. fmfinishinstall includes MyPoints id, app id, and UDID

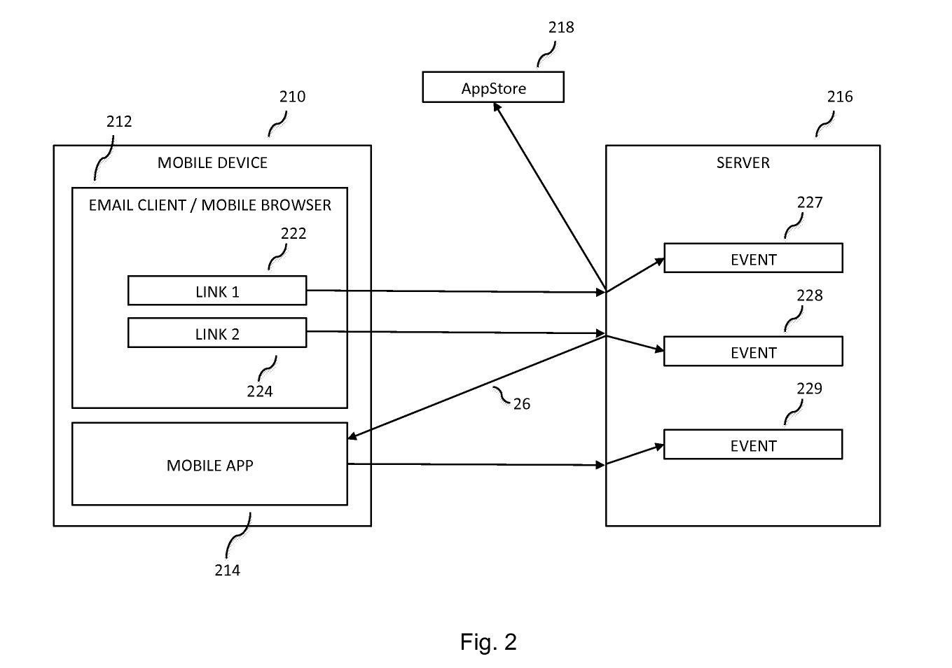

and the final event is what is needed to reward the user for installing the application. FIG. 2 illustrates the flow of events and clicks, and how the MyPoints id may be matched to the user's device id (UDID).

In FIG. 2, this is illustrated in the following manner. The owner or user of a mobile device 210 wishes to download an application 214 from the AppStore 218. Mobile device 10 includes at least an e-mail client/mobile browser portion 212. The user contacts the AppStore 218 to download a desired application. To facilitate the download of the application, e-mail may be sent to the mobile device e-mail/browser portion 212. The e-mail includes two links, a first link 222 for downloading the desired application and a second link 224 for rewarding the user for downloading the application. The user is instructed to click on the first link 222. As described above, clicking on this link causes the server 16 to redirect the user to AppStore 218 and download the mobile application 214. This event 227 is recorded in a database, such as server 216. The user is also instructed to click on the second link 224. Clicking on this link also causes the event 228 to be recorded in the server. As noted above, clicking on this second link also causes the server 216 to redirect the user to another link 226 which redirection may be transparent to the user. When this link is connected, it also opens the application 214 on the user's mobile device or phone. When the application opens, the parameters of the redirection URL will be fed into a method in the application that begins a third step. Thus, the application opens and makes a call to another URL. The server 16 records this as a third event 229. Recording the third event triggers a reward to the user. Rewards to the user may also be tracked by the server and reported to the AppStore and the third party provider, i.e., the application provider who would also appreciate wider use of the application.

In embodiments, methods and systems may utilize offline tracking, such as through MyPoints. The following will describe MyPoints as an example third-party service that the system may be associated with, but is not meant to be limiting in any way. In order for MyPoints members to receive their Points, MyPoints and advertisers need to identify and track MyPoints members as they complete incented transactions at the advertisers' sites. This may require that the two work together to establish a method for tracking members' behavior from click to conversion. Offline Tracking is a process whereby the advertiser captures and stores a specific MyPoints member identifier. This member identifier, along with other information specific to the member's transaction, is then uploaded into the MyPoints system as a flat text file, in a pre-determined format at the conclusion of a campaign. Points are then awarded to the member.

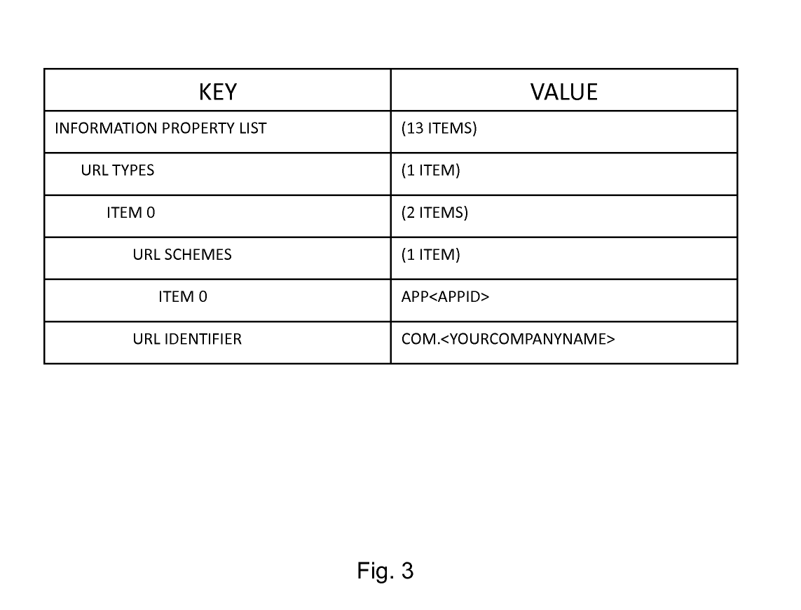

In embodiments, the system's tracking code integrated by the publisher application may include methods to register for custom URLs. These custom URLs allow the system to capture URLs of the form app:// and allows tracking the installation of the application by matching MyPoints member identifier from email or web with the user's device ID (UDID). On Apple's iOS platform, capturing custom URLs of the sample form above requires two changes to the Info.plist for the publisher's application (typically named YourAppInfo.plist). The two keys that must be added are a URL identifier and a URL scheme. The URL identifier should be unique and contain the name of the publisher company. The URL scheme must be in the format app<APPID>, where <APPID> is replaced with the publisher application's Apple Application Identifier. FIG. 3, a picture Tracking-plist-example.png, shows the added custom URL types. When this is done and the device's browser is pointed to a link of the form app<APPID>://launch that launches the publisher's application.

Upon launch, the publisher's application communicates tracking information to the system's servers. For instance, on Apple's iOS platform, the publisher's application's applicationDidFinishLaunchingWithOptions includes a call to:

[self handleURL:[launchOptions objectForKey:UIApplicationLaunchOptionsURLKey]];
[self performSelectorInBackground:@selector(uploadFluentTracking:) withObject:nil];
and the AppDelegate class file includes the following methods:
- (void)uploadFluentTracking:(NSDictionary *)opts {

NSAutoreleasePool *pool = [[NSAutoreleasePool alloc] init];
NSString *appid = @“<APPID>”;
NSMutableString *fluentURL =

[NSMutableString stringWithString:@“http://track.fluentmobile.com/conversion?”];

[fluentURL appendFormat:@“app=%@”, appid];
[fluentURL appendFormat:@“&udid=%@”, [UIDevice

currentDevice].uniqueIdentifier];

[fluentURL appendFormat:@“&device=%@”, [UIDevice currentDevice].model];
[fluentURL appendFormat:@“&app_version=%@”, [[[NSBundle mainBundle]

infoDictionary] objectForKey:@“CFBundleVersion”]];

if (nil != opts) {

[fluentURL appendFormat:@“&name=%@”, [opts valueForKey:@“event”]];
[fluentURL appendFormat:@“&tvalue=%@”, [opts valueForKey:@“tvalue”]];
[fluentURL appendFormat:@“&ivalue=%@”, [opts valueForKey:@“ivalue”]];

} else {

[fluentURL appendFormat:@“&name=%@”, @“Launch”];

}
NSString *percentEscapedFluentURL = [fluentURL

stringByAddingPercentEscapesUsingEncoding:NSUTF8StringEncoding];

NSURLRequest *request = [NSURLRequest requestWithURL:[NSURL

URLWithString:percentEscapedFluentURL]];

NSURLResponse *response = nil;
NSError *error = nil;
[NSURLConnection sendSynchronousRequest:request returningResponse:&response

error:&error];

if((!error) && ([(NSHTTPURLResponse *)response statusCode] == 200)) {

NSLog(@“Successfully uploaded tracking information to Fluent Mobile”);

} else {

NSLog(@“Failed to upload tracking information to Fluent Mobile”);

}
[pool release];

}
- (BOOL)handleURL:(NSURL *)url {

if (!url) { return NO; }
if (![[url scheme] hasPrefix:@“app”]) { return NO; }
NSAutoreleasePool *pool = [[NSAutoreleasePool alloc] init];
NSMutableDictionary *opts = [NSMutableDictionary dictionaryWithCapacity:3];
[opts setObject:[url host] forKey:@“name”];
NSArray *params = [[url query] componentsSeparatedByString:@“&”];
for (NSString *q in params) {

NSArray *p = [q componentsSeparatedByString:@“=”];
[opts setObject:[p objectAtIndex:1] forKey:[p objectAtIndex:0]];

}
[self performSelectorInBackground:@selector(uploadFluentTracking:)

withObject:opts];

[pool release];
return YES;

}
where the <APPID> is replaced with the application's Apple Application ID.

In a non-limiting example use case, the advertiser may then capture and store member information, such as the member identifier passed as a variable on the URL string provided for the campaign, e.g.:

http://www.yoursite.com?id=<ID_Here>.

In embodiments, the primary and recommended advertiser identifier to be captured and stored may provide a way to track the member through the process. In embodiments, there may be a member use ID that may be encoded with additional information, such as including the actual email or Web offer though which the member clicked, resulting in processing once uploaded into the advertiser system. Additional information a user may be asked to provide in the Offline file may include, date and time of transaction, purchase amount or number of units purchased, and the like. In addition, an email address may be used as an identifier, and the like. In embodiments, in order to provide an optimized points-earning experience for a member, an advertiser may require that transaction data be returned within a period of time, such as days, weeks, and the like.

In embodiments, methods and systems may track application launches, relay launch information to ad networks, import or scrape information about ad campaigns and app ranking, present information to client services and application client, assist client services managing campaign modifications, and the like. For tracking application launches, system code may be installed in applications on the platform (e.g. iPhone and Android Apps), touch-point (testing) may be required to ensure the app is installed correctly, posts may launch an event via web service, such as transmitting at least an app id and unique device id, minimal parameter validation done at post time, and the like. Relay launch information may be provided to ad networks, such as with conversion uploaders, where there may be one per ad network, posts each initial launch event (e.g. a ‘conversion’) to each ad network, and the like. Information may be imported or scraped about ad campaigns and app ranking, where imports may use web services/APIs when possible, scrapping may be hand coded lifting of data from websites, and the like. Campaign information per day may include impressions, clicks, conversions, cost, bit, budget, and the like. Appstore rankings and ratings may be used.

In embodiments, a tracking service facility may receive an event, such as using a web service, providing validation, storing in a tracking database, and the like. The tracking database facility may store events posted by mobile applications, such as launching, resuming, conversion, and the like, and where the facility is built for speed, such as through de-normalized schema, partitioned tables, and the like.

An essential element in any advertising campaign is the tracking of its influence. Influence in the online and mobile world is generally determined using metrics, such as how often the advertisement is seen (known as an impression), how often the impression is interacted with (known as a click), how often a click results in the completion of an advertising goal (known as a conversion), and the like. The conversion may be the purchase of a product, the download and installation of an application, registration with a service, and the like.

Tracking the flow of an advertising campaign may require some mechanism that ties together various events (e.g. impression, click, and conversion). As stated herein, in the mobile ecosystem this may be particularly difficult. To date the primary form of tracking for advertisements in mobile applications that lead to actions with other applications (such as installation, registration, etc.) is to obtain an identifier that uniquely describes a specific device such as the UDID found on Apple iOS devices, Android IDs found on Android OS devices, and cellular network identifiers (ESN/IMEI/MEID). If this identifier is obtained in the application that publishes the ad and in the application that is to be installed or used as the object of that advertisement, then the two can be linked together by the system that has both of these pieces of information.

In the mobile ecosystem this is notoriously difficult when matching advertisements published in anything other than an application that one wants to match to the eventual installation of another application. Examples of places to publish advertisements that cannot easily be tracked to installs and use of mobile applications are web pages, SMS, Email, web offer walls, QR codes, and the like. Applications are typically “sandboxed” such that they cannot directly share information with one another or with system applications such as web browsers and email clients. Further, it is typically not possible to access uniquely identifying data directly from web pages as privacy controls prevent web pages from accessing that data.

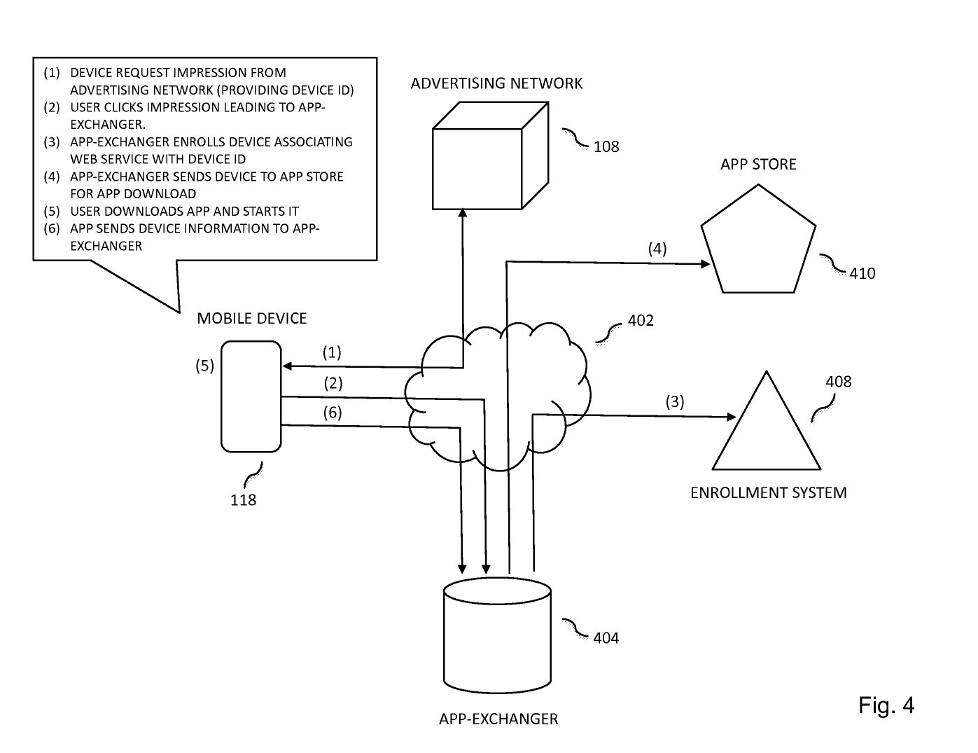

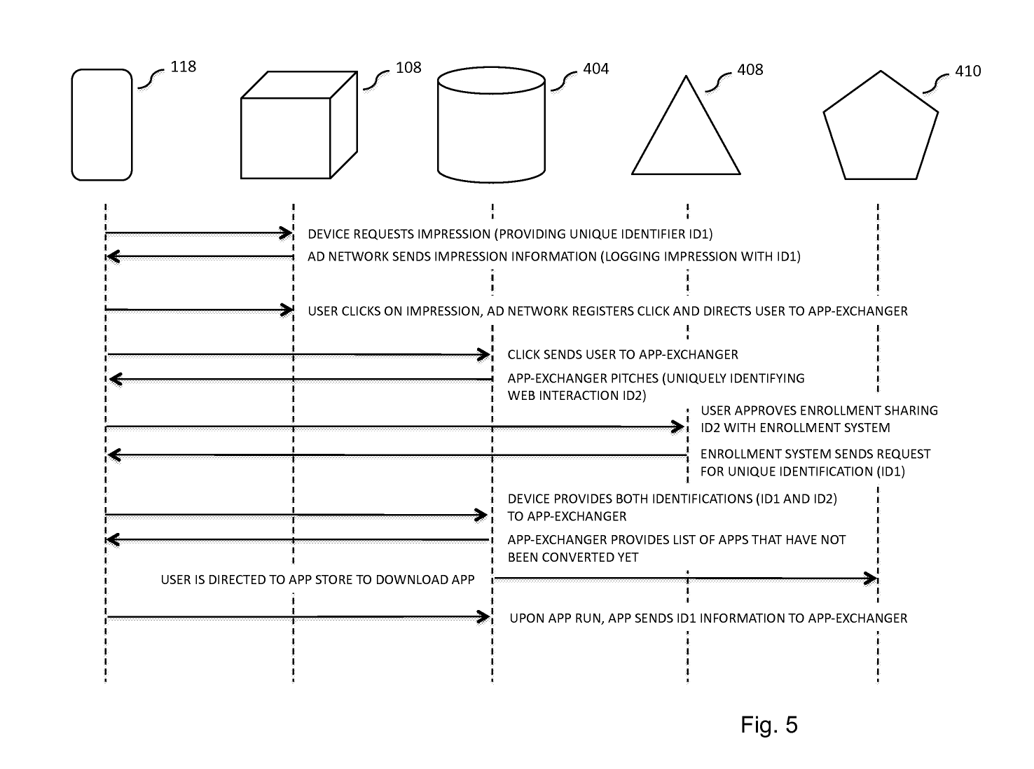

Referring to FIGS. 4 and 5, in embodiments methods and systems may be able to provide tracking despite not having access to the initial UDID (unique device identifier), using applications, profiles, or other remotely installed software specifically used for obtaining tracking information as part of an advertisement, offer wall, email offer, and the like. For instance, on iOS the Enterprise Deployment profiles, the mobile device management server, and the like may permit a web site to prompt for the installation of a temporary enterprise profile that can redirect information back to the originating site and include the UDID as part of the response. FIGS. 4 and 5 depict an embodiment process flow in six representative steps. In step 1, a mobile device 118 may request an impression from an advertising network 108 (providing the device ID). In step 2, a user 114 may click an impression leading to the app-exchanger 404 as described herein. In step 3, the app-exchanger 404 may enroll the device 118 through an enrollment system 408, associating a web service with the device ID. In step 4, the app-exchanger 404 may send the device to a app store 410 (e.g. iTunes Store) for app download. In step 5, the user 114 may download the app and start using it. Finally, in step 6, the app may send device information to the appexchanger 404. In embodiments, the MDM server may send push notifications to the device to collect more information, such as the current list of apps installed and other state and identifying information about the device.

In embodiments, there may be other methods of accomplishing similar installs of enterprise configuration management, special applications designed to communicate identifiers as part of an advertising process, and the like. Other installations of scripts, binaries, configurations, and the like may also be possible. For instance, an application may be specifically designed to present pitches and incentivized actions (e.g. much like a browser but directly supplying the UDID to the web service so it may track the conversion).

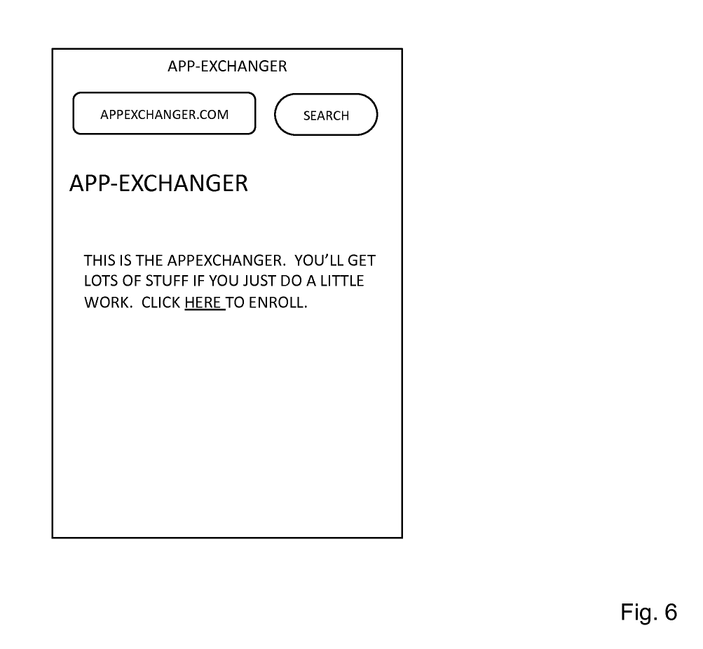

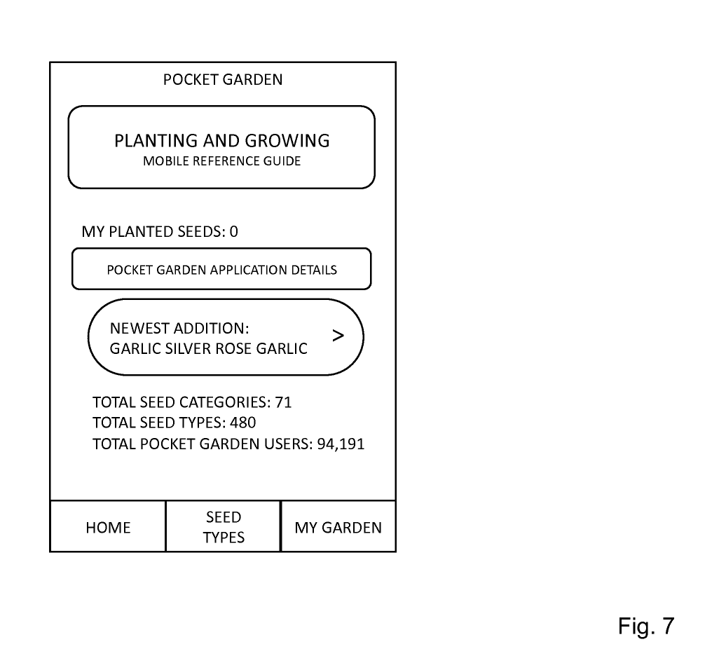

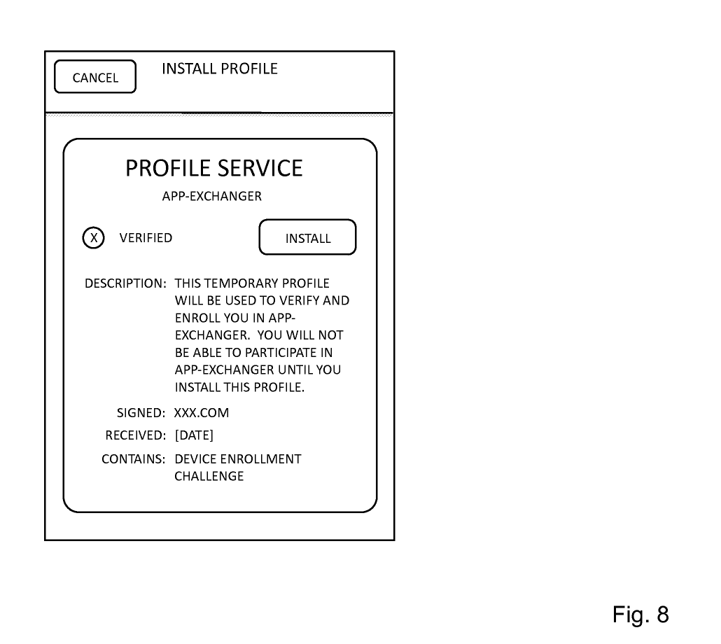

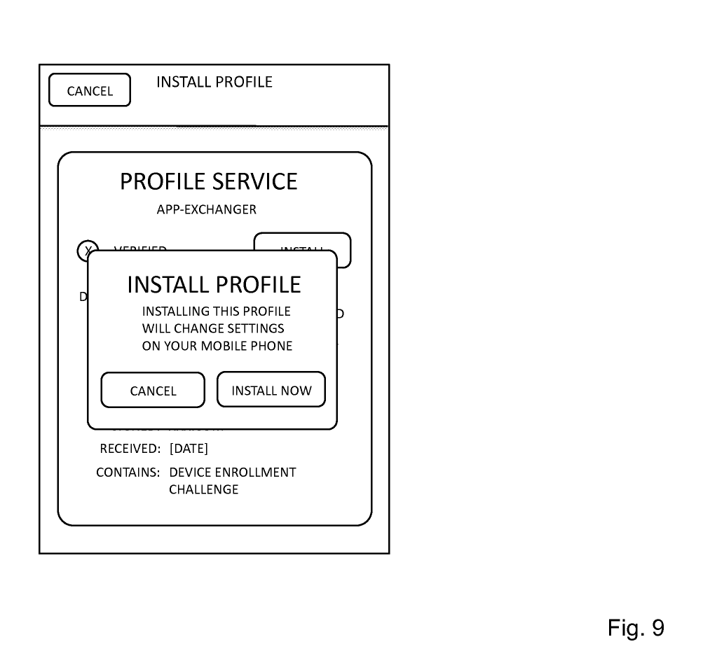

Referring to FIGS. 6-9, an example of how an applications exchanger may be used is shown as part of the following set of messages, where FIG. 6 presents the application exchanger, FIG. 7 presents a web page with an embedded advertisement, FIG. 8 presents a profile service, and FIG. 9 presents a notice to the user to install the profile.

In embodiments, techniques disclosed herein may be used for tracking downloads by users of other digital media, such as music. For instance, an individual may be searching for new music on a music purchase application site (e.g. iTunes), where choices of music are presented, such as by artist, album, genre, and the like. In addition, music choices may be presented based on popularity of the song, such as through a ranking indicator that ranks the song based on the number of times the song has been downloaded, and the like, which is an indication of the song's popularity. Techniques of the present disclosure may provide methods to incentivize a user to download a particular song from the site through an offer of a reward as described herein, such as in this instance, a free additional song of the user's choice, a gift card for at least one song, a free download of another type of digital media, the ability to keep the song being incentivized, and the like. For example, a user of a mobile device may be incentivized with an offer of a free song if they follow a procedure for downloading a specified song in the offer, where the user is asked to select multiple links, as described herein, that enable the system to track the download, and provide a free song as a reward to the user. In another example, the download may be tracked through utilizing facilities native to the user's mobile device, such as to obtain the user ID of the device for the download, as described herein, retrieving the user ID from the mobile device, obtaining the user ID from a content provider as a result of the download, comparing the ID from the mobile device and from the download, and if the same, provide the reward to the user. In this way, the specified song may receive an increased number of downloads, and thus receive a higher rating when the specified song is presented to the music purchase application site. And, as the listing of songs on the music purchase application site may be rank ordered as a function of popularity (e.g. which is proportional to the number of times the song has been downloaded), this increases the visibility of the specified song to users of the site, and thus a potential increase in the revenue generated by the song. This increased revenue, may be then used to further incentivize other users.

In an example, a ‘native facility’ may be a provisioning profile, mobile device management servers, and the like, and may include XML files that contain device security policies and restrictions, VPN configuration information, Wi-Fi settings, email and calendar accounts, and authentication credentials, and the like, that permit the mobile device to work with an enterprise systems.

Tracking of user app downloads and other digital media when the user is in a mobile web-browser environment may require statistical methods that link the user's behavior when they are downloading content more directly, such as through an app store or music app on their mobile device, due at least in part to the fact that user actions when using a mobile browser may be hidden through sandboxing, and thus, less accessible. In embodiments, valid projections may be made between a user's reactions to an advertisement associated with an app download environment and an advertisement associated with a web app download environment. That is, projections may be made relating a user's reaction to advertisements when they are in a mobile device app download mode to when a user is downloading while on the web through their mobile device browser. This technique may be referred to as user ‘fingerprinting’, such as applied to a web advertising campaign (WAC). This technique may take advantage of user-related data that may be common between an app download environment and a web browsing environment, such as IP address, device type, user agent information, browser version, operating version, color depth, screen resolution, CPU speed, language, time zone settings, clock calibration, and the like. In an example scenario, a thousand people may click on advertisements associated with a particular app download, and an hour later it is observed that ten people have installed the app. The system may then match IP addresses, device type, OS version, and the like, to infer to some level of confidence that there was a match.

In embodiments, there may be other considerations to taken into account in the implementation of the fingerprinting process, such as accounting for when a router changes a user's device IP address to the router's IP address when users are in a common public place. In this instance, a user is on a public connection point, such as at a Starbucks, and the IP addresses from the connection point may be shared among many people. So there may be ambiguity about the match being from any one of the people connected through the router. However, and referring again to the example of a thousand people clicking on the advertisement, statistically the present invention may be able to infer that ‘x’ of the ten who installed the app were from a given advertising campaign.

In embodiments, the system may be predictably scalable, where a factor is utilized to get to the correct result. The system may calculate the ratio between advertisement exposure and downloads in the app-to-app advertising world where the system has definitive knowledge of the ratio, and then applies that ratio to the web advertising-to-app download world, where the system doesn't have definitive knowledge due to false negatives and false positives. For instance, inside an app the system may have access to the device/OS and IP address, and run a campaign in app-to-app traffic (that is, advertisements shown in one app and downloaded in another app in response to that ad). In this instance, the system may link based on the match between device/OS and IP. In embodiments, the system may repeat this multiple times, and measure characteristics between the overlap and the kinds of devices, determining the number of false positives (where the downloading of an app is by a second person and coincidentally occurs in close proximity in time after the ad) and false negatives (e.g., where a single person downloads in response to an ad, but something, such as an IP address change, obscures that fact). As another example, one person may click on the advertisement, and someone else downloads the application, but they share an IP address. This is another example of a false positive. The system may run the matching algorithm with the UDID as a baseline. This may allow the system to determine the number of false negatives and false positives in one environment in comparison to the definitive environment that uses the UDID and subsequently determine a scaling factor, which may be particular to that particular advertisement or that particular app. The system may apply that app-specific scaling factor in the mobile web advertisement-to-mobile app download world, where the system doesn't have the UDID-based process as a baseline. However, the system may rely on the projection from the more definitive data from the app ad-to-app download world to make the match.

In embodiments, to get good scaling factors, the system may learn about IP addresses, such as how they are shared (e.g. as popular addresses from AT&T or Starbucks), distributions of device types, distributions of browser types, and the like. For example, the system may ignore all the IP addresses that are known as widely shared in calculating the scaling factors to get a more stable scaling factor that is less sensitive to the sharing of the same IP address among different users.

In embodiments, there may also be a temporal component included along with the inference associated with fingerprinting, such as to limit the time of consideration. For example, if an individual clicked on an advertisement associated with an app download and didn't install the download for six hours, the system may turn off inference.

The present invention may provide for a statistically valid form of user action fingerprinting, utilizing an algorithm for matching and estimation of real conversion rates between advertising (web or mobile) and mobile application downloads.

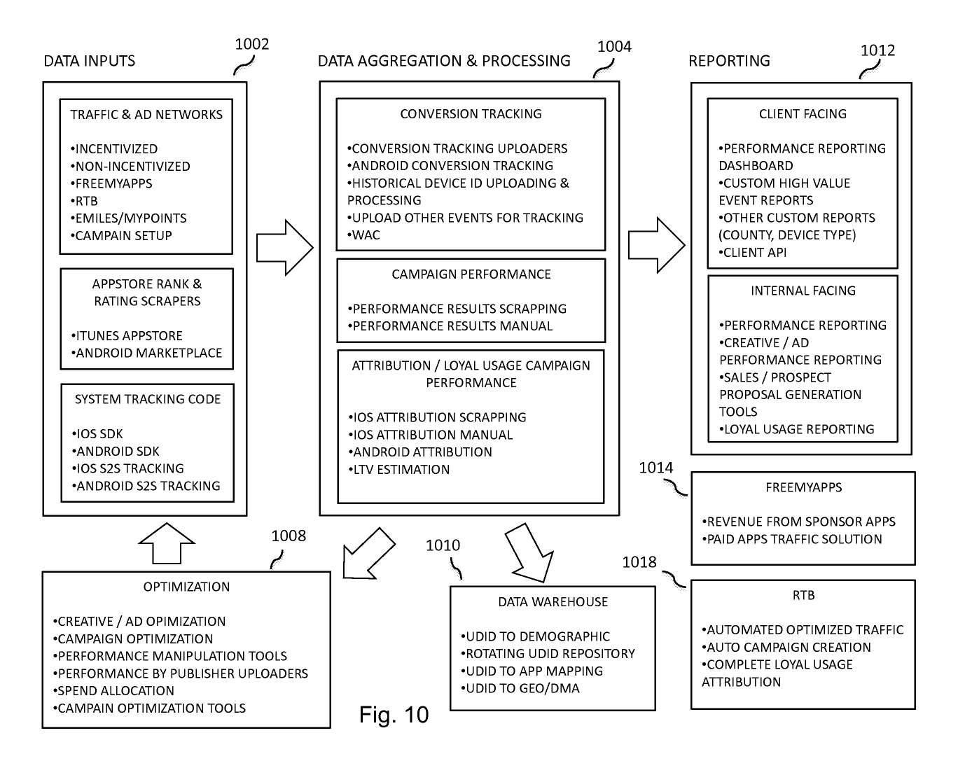

Referring to FIG. 10, a functional block diagram in an embodiment of the present invention is presented, including data inputs 1002, data aggregation and processing 1004, optimization 1008, a data warehouse 1010, reporting 1012, a freemyapps facility 1014, and RTB 1018. In embodiments, data inputs 1002 may include traffic and ad networks, including incentivized and non-incentivized traffic; scrapper inputs for rank and rating, and the like. Data aggregation and processing 1004 may include conversion tracking, campaign performance, attribution and loyal usage campaign performance, and the like. Reporting 1012 include different interfaces, such as a client facing interface, an internal facing interface, and the like. In an example embodiment, a user 114 may provide data input 1002 resulting from they're responding to an incentivized download campaign, where the data input may include information from the user's mobile device 118, a web store 410, and the like. The data input 1002 may then be collected and processed by the data aggregation and processing facility 1004, such as including download tracking management 124. The processed data product may then be sent to the optimization facility 1008 for further use in gathering data, stored in the data warehouse 1010, and the like. In addition, the user 114 may be provided with a client facing interface as part of the reporting facility 1012 functionality, where the user 114 may view incentives related to user content 120, incentives from a content provider 112, an offer wall 122, and the like.

In embodiments, the present invention may provide for mobile digital media download incentive management through multiple user action tracking In an example, the solution to computer systems such as iPhones/iPads lacking a means for linking user actions may be to require the user to help make the linking between a first user action (e.g. first click) and the later install by a second user action (e.g. the user clicking on a second link) This may work when the user has some kind of incentive to help the system make the link. Note that this may apply to any ‘mobile digital media’, such as apps, music, games, and the like. In embodiments, a method of tracking downloads in a computer system that includes a mobile electronics device may comprise providing an incentive to a user of the mobile electronics device for the download of digital media content; receiving a request for the digital media content from the user of the mobile electronics device; sending the user an electronic communication to the mobile electronic device including a first web-based link and a second web-based link that the user is instructed to activate in a specified order to receive both the digital media content and the incentive, wherein the user is to first activate the first link and then the second link, and wherein the first and second links contain an embedded user identifier; receiving an indication of the user having activated the first web-based link, wherein activation of the first web-based link results in receiving the user identifier that was embedded in the first link and enables the user to download the digital media content to the mobile electronics device; receiving an indication of the user having activated the second web-based link, wherein activation of the second web-based link results in receiving the user identifier that was embedded in the second link and enables the user to open the digital media content on the mobile electronic device, creates a confirmation event through matching of the two received user identifiers present in the activation of the first and second web-based links, and provides the user with the incentive; and the like. The digital media content may be an application, music, a game, and the like. The incentive may be a free application, reward points, virtual currency, and the like. The confirmation event may be generated at least in part from the mobile electronic device being caused to direct a call to a URL and to record the call as the confirmation event as a result of receiving the indication of the user having activated the second web-based link.

In embodiments, the present invention may provide for a mobile digital media download incentive management through tracking of an ID stored in native facilities of the mobile device. The source of the user identifier may come from a native facility of the mobile device, such as a provisioning profile, mobile device management servers, and the like. In embodiments, a method of tracking downloads in a computer system that includes a mobile electronic device may comprise providing an incentive to a user of a mobile electronics device for the download of digital media content, wherein the incentive requires the user to provide access to an identifier of the user's mobile device that is stored as a native facility on the mobile device; receiving a request for the digital media content from the user of the mobile electronics device as the result of the incentive, wherein the request includes access to the identifier; sending the user an electronics communication to the mobile electronic device including a first web-based link and a second web-based link that the user is instructed to activate in a specified order to receive both the digital media content and the incentive, wherein the user is to first activate the first link and then the second link, and wherein the first and second links contain the identifier; receiving an indication of the user having activated the first web-based link, wherein activation of the first web-based link results in receiving the identifier and enables the user to download the digital media content to the mobile electronics device; receiving an indication of the user having activated the second web-based link, wherein activation of the second web-based link results in receiving the identifier and enables the user to open the digital media content on the mobile electronic device, creates a confirmation event through matching of the two received identifiers present in the activation of the first and second web-based links, and provides the user with the incentive; and the like. The native facility that stores the identifier may be a provisioning profile, mobile device management server, and the like. The device management server may be used to verify an installation of an application by viewing whether the application is installed, prompting the user to install it, and then checking with the device management server to verify that the application has been installed. The digital media content may be at least one of an application, music, a game, and the like. The incentive may be a free application, reward points, virtual currency, and the like. The confirmation event may be generated at least in part from the mobile electronic device being caused to direct a call to a URL and to record the call as the confirmation event as a result of receiving the indication of the user having activated the second web-based link.

In embodiments, the present invention may provide mobile digital media download tracking management utilizing statistical user fingerprinting techniques through correlation of web-based download user actions with mobile application download user actions. Statistical analysis of an aggregate response to a particular advertisement may be used to determine the effectiveness of the advertisement, such as to optimize its placement. In this instance, to correlate user actions between a web-based environment and an app download environment. Many factors may contribute to the fingerprint, such as device screen size, screen color depth, processor speed, installed plug-ins and apps, library versions, and the like. Techniques may also may eliminate commonly shared fingerprints that produce false positives and to account for the rate at which user's fingerprints change and to account for partial matching in fingerprints. In embodiments, a method of tracking downloads in a computer system that includes at least one mobile electronics device may comprise providing an incentive to a plurality of users of mobile electronics devices for the download of digital media content, wherein the incentive is provided through both an app download environment and a web browsing environment; receiving a first indication from at least one of the plurality of users that demonstrates interest in the incentive in at least one of the environments, wherein the indication provides user-related data; receiving a second indication from at least one of the plurality of users from the other environment, wherein the indication provides user-related data that enables matching it to the user-related data from the received first indication; determining a correlation between the user related data from the first indication and the user-related data from the second indication to predict a user action in at least one of the environments; sending the user of the matched user-related data an electronic communication to their mobile electronic device that includes a link that offers the user the incentive to receive both the digital media content and the incentive while maintaining an indicator of the matched user-related data; receiving an indication of the user having activated the link, wherein activation of the link results in receiving an indicator of the matched user-related data; providing the user with the ability to download the digital media content and receive the incentive, and the like. The digital media content may be an application, music, a game, and the like. The incentive may be a free application, reward points, virtual currency, and the like. Tracking the download of the digital media content and the incentive may be on a per-user basis.

In embodiments, the present invention may provide for temporal tracking of mobile user behavior with respect to web-based advertisements associated with temporary and keyed ID use in digital media content, such as a method for tracking general user actions though time. In embodiments, a method of tracking downloads in a computer system may comprise providing an incentive to a plurality of users of mobile electronics devices for the download of digital media content; receiving a first indication from at least one of the plurality of users that demonstrates interest in the incentive, wherein the indication provides a first application-specific user identifier; receiving a second indication from at least one of the plurality of users that demonstrates interest in the incentive, wherein the indication provides a second application-specific user identifier that matches the first application-specific user identifier from the received first indication; sending the user of the matched application-specific user identifier an electronics communication to the user's mobile electronic device that includes a link that offers the user both the digital media content and the incentive, while maintaining an indicator of matched application-specific user identifier; receiving an indication of the user having activated the link, wherein activation of the link results in receiving the matched application-specific user identifier; providing the user with the ability to download the digital media content and receive the incentive; and the like. The application-specific user identifier may be a time-limited user identifier. The application-specific user identifier may be a user identifier that is keyed to a specific application. The digital media content may be at least one of an application, music, a game, and the like. The incentive may be at least one of a free application, reward points, and virtual currency.

In embodiments, the present invention may provide rewarding a user for downloading a free app with the right to use another app, such as including a process flow where a user downloads free apps, and a reward is provided to the user as a right to use a paid app, but may also include any incentive as described herein, including free apps. In embodiments, a method of tracking downloads in a computer system may comprise providing an incentive to a plurality of users of mobile electronics devices for the free download of a first digital media content where the incentive for the first digital media content is linked through a set of subsequent user actions with the first digital media content to a further incentive for the right to download of a second digital media content; receiving a request for the first digital media content from the user of the mobile electronics device as the result of the incentive, wherein the request includes a user identifier; tracking the user's actions with the first digital media content using the user identifier; providing the user with the right to download the second digital media content when the user satisfies the incentivized linked user actions associated with the first digital media content; and the like. The first and second digital media content may be an application, music, a game, and the like. The incentive may be a free application, reward points, virtual currency, and the like.

In embodiments, the present invention may include a plurality of types of mobile platforms, such as a smart phones, music players, game platforms, e-Readers, tablets, personal computers, navigation devices, and the like, and a plurality of types of applications, such as games, music, entertainment, business, books, education, finance, lifestyle, medical, navigation, news, photo and video, productivity, reference, sports, travel, utilities, weather, and the like. Incentives may include additional downloads, additional free downloads, virtual money for use in an application, points to earn toward an additional incentive, travel points, reward points, coupons, credits, subscription credit, publications, upgrades (e.g. to a new version, to a new level, for addition function), ranking (e.g. a user is ranked publicly for an incentivized activity, and the like. Types of user IDs may include a proxy ID, personal user ID, mobile device user ID, application user ID, temporary ID, MAC address, an ID derived from ‘fingerprint’ information, tracking and correlating identifier use through time, and the like. Markets where the present invention may be applied may include consumer, commercial, government, medical, gaming, music, travel, navigation, retail, wholesale, and the like.

While the invention has been described in connection with certain preferred embodiments, other embodiments would be understood by one of ordinary skill in the art and are encompassed herein.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method of tracking downloads in a computer system, the method comprising:
providing an incentive to a plurality of users of mobile electronics devices for the download of digital media content;
receiving a first indication from at least one of the plurality of users that demonstrates interest in the incentive, wherein the indication provides a first application-specific user identifier;
receiving a second indication from at least one of the plurality of users that demonstrates interest in the incentive, wherein the indication provides a second application-specific user identifier that matches the first application-specific user identifier from the received first indication;
sending the user of the matched application-specific user identifier an electronic communication to the user's mobile electronic device that includes a link that offers the user both the digital media content and the incentive, while maintaining an indicator of matched application-specific user identifier;
receiving an indication of the user having activated the link, wherein activation of the link results in receiving the matched application-specific user identifier; and
providing the user with the ability to download the digital media content and receive the incentive.

2. The method of claim 1, wherein the application-specific user identifier is a time-limited user identifier.

3. The method of claim 1, wherein the application-specific user identifier is a user identifier that is keyed to a specific application.

4. The method of claim 1, wherein the digital media content is at least one of an application, music, video, and a game.

5. The method of claim 1, wherein the incentive is at least one of an application, reward points, music, video, game, and virtual currency.

6. A method of tracking an incentivized action in a computer system, the method comprising:
providing an incentive to a plurality of users of mobile electronics devices for the use of a digital media content;
receiving a first indication from at least one of the plurality of users that demonstrates interest in the incentive, wherein the indication provides a first application-specific user identifier;
receiving a second indication from at least one of the plurality of users that demonstrates interest in the incentive, wherein the indication provides a second application-specific user identifier that matches the first application-specific user identifier from the received first indication;
sending the user of the matched application-specific user identifier an electronic communication to the user's mobile electronic device that includes a link that offers the user both the use of the digital media content and the incentive, while maintaining an indicator of matched application-specific user identifier;
receiving an indication of the user having activated the link, wherein activation of the link results in receiving the matched application-specific user identifier; and
providing the user with the ability to use the digital media content and receive the incentive.

7. The method of claim 6, wherein the use of the digital media content includes the purchase of the digital media content.

8. A method of tracking an incentivized action in a computer system, the method comprising:
providing an incentive to a plurality of users of mobile electronics devices for a web-based service;
receiving a first indication from at least one of the plurality of users that demonstrates interest in the incentive, wherein the indication provides a first application-specific user identifier;
receiving a second indication from at least one of the plurality of users that demonstrates interest in the incentive, wherein the indication provides a second application-specific user identifier that matches the first application-specific user identifier from the received first indications;
sending the user of the matched application-specific user identifier an electronic communication to the user's mobile electronic device that includes a link that offers the user both the web-based service and the incentive, while maintaining an indicator of matched application-specific user identifier;
receiving an indication of the user having activated the link, wherein activation of the link results in receiving the matched application-specific user identifier; and
providing the user with the ability to use the web-based service and receive the incentive.

9. The method of claim 8, wherein the web-based service is an in-app purchase.

10. The method of claim 9, wherein the in-app purchase is a purchase of a premium membership at a discount.
